(19) United States
(12) Patent Application Publication
(10) Pub. No.: US 2019/0154048 A1
(43) Pub. Date: May 23, 2019

(54) VEHICLE HAVING A PUMP DEVICE

(71) Applicant: Schaeffler Technologies AG & Co. KG, Herzogenaurach (DE)

(72) Inventor: Michael Schneeweis, Hagenbüchach (DE)

(73) Assignee: Schaeffler Technologies AG & Co. KG, Herzogenaurach (DE)

(21) Appl. No.: 16/085,728

(22) PCT Filed: Feb. 9, 2017
(86) PCT No.: PCT/DE2017/100096

§ 371 Date: Sep. 17, 2018

(30) Foreign Application Priority Data
Mar. 16, 2016 (DE) 10 2016 204 301.3

(51) Int. Cl. F04D 29/049; F01P 5/12; F04D 29/06; F04D 29/12; F04D 29/02; F16C 19/08; F16C 33/62; F16C 37/00; F16C 33/66

(52) U.S. Cl. CPC F04D 29/049; F01P 5/12; F04D 29/061; F04D 29/126; F04D 29/026; F16C 19/08; F16C 2360/44; F16C 37/007; F16C 33/6637; F01P 2005/125; F16C 2300/42; F16C 2360/22; F16C 33/62

(57) ABSTRACT

A coolant pump is provided that includes a pump housing that receives a pump shaft for driving a pump member for a liquid medium in a medium chamber. The pump shaft is arranged at least in sections in the medium chamber and is rotatable mounted by means of an anti-friction bearing. The anti-friction bearing has a plurality of rolling bodies which are arranged in a rolling body chamber. The rolling body chamber and the medium chamber are fluidly connected, such that the anti-friction bearing device is lubricated and/or can be lubricated with the medium from the medium chamber.

### CROSS-REFERENCE TO RELATED APPLICATIONS

This application is the U.S. National Phase of PCT Application No. PCT/DE2017/100096 filed Sep. 21, 2017 which claims priority to DE 102016204301.3 filed Mar. 16, 2016, the entire disclosures of which are incorporated by reference herein.

### TECHNICAL FIELD

The invention relates to a vehicle having a coolant pump.

### BACKGROUND

Coolant pumps are frequently used in vehicles in order to pump coolant in a coolant system through the motor, in particular through the internal combustion engine, of the vehicle. Coolant pumps of this type have a pump shaft and an impeller, which is connected fixedly to the pump shaft so as to rotate with it. The pump shaft is mounted rotatably in a pump housing. In order to avoid coolant passing out of the region of the impeller into the housing and, in particular, to the bearing of the pump shaft, sealing rings are used which protect the bearing in the housing against the coolant.

DE 10 2006 054 743 A1, for example, which probably forms the closest prior art, discloses a coolant pump having a rotor shaft, at least one impeller on the rotor shaft, and at least one antifriction bearing assembly, wherein the rotor shaft is mounted rotatably in a housing by means of the antifriction bearing assembly. To avoid coolant penetrating into the antifriction bearing assembly, seals are provided on both sides of the antifriction bearing assembly.

DE 100 57 099 C2 discloses a coolant pump having a pulley for internal combustion engines.

### SUMMARY

It is the object of the present disclosure to propose a vehicle having a coolant pump which represents an alternative to the prior art. This object is achieved by a vehicle having a coolant pump with the features described herein. Preferred and advantageous embodiments of the disclosure will also become apparent from the following description and the attached figures.

The disclosure relates to a vehicle having a pump which is designed as a coolant pump for an internal combustion engine of the vehicle. The function of the coolant pump is to deliver a liquid medium. In particular, the pump is designed as a continuous-flow machine.

The pump has a pump shaft for driving a pump member. The pump member optionally forms part of the pump. In particular, the pump member is designed as an impeller. The pump shaft can be connected fixedly to the pump member so as to rotate with it. The pump shaft projects at least in some section or sections into a medium chamber, wherein the liquid medium is arranged in the medium chamber, with the result that the pump member is arranged in the medium chamber and/or in the liquid medium. The liquid medium optionally forms part of the pump. Provision is made for at least 50 percent, at least 80 percent and, at least 95 percent, of the free volume in the medium chamber to be filled with the liquid medium. The pump shaft defines an axis of rotation, wherein the pump member is rotatable about the axis of rotation and/or is rotated around said axis during the operation of the pump.

The medium chamber is understood to mean the volume in which the liquid medium is arranged for the intended purpose. In particular, one section or a free end of the pump shaft, which carries the pump member, is arranged in the medium chamber.

The pump furthermore has a pump housing section for accommodating the pump shaft. In particular, the pump shaft is accommodated rotatably and/or with bearing support in the pump housing section.

The pump has an antifriction bearing, wherein the antifriction bearing has a plurality of rolling elements. The rolling elements can be rollers and/or balls. The rolling elements are arranged in a rolling element chamber of the antifriction bearing. The rolling element chamber is preferably delimited radially on the inside and outside by raceways for the rolling elements. The pump shaft is mounted in the pump housing section via the antifriction bearing. In particular, the antifriction bearing is designed as a radial antifriction bearing. For example, the antifriction bearing can be designed as a double-row ball bearing or as an antifriction bearing which has at least one or precisely one row of rollers and at least one or precisely one row of balls as an antifriction bearing.

In the context of the invention, the proposal is that the rolling element chamber and the medium chamber are connected in terms of flow, in particular in such a way that the liquid medium enters the rolling element chamber from the medium chamber via the flow connection. A pump which is, in principle, constructed in this way is disclosed by DE 20 2007 003 214 U1, for example.

The flow connection ensures that the rolling element chamber is also supplied with the liquid medium, with the result that the antifriction bearing is lubricated with the medium from the medium chamber.

It is one consideration of the disclosure here that the liquid medium likewise has lubricating properties, and therefore there is a departure from the traditional approach of separating the liquid medium and the rolling element chamber in terms of flow in order to lubricate the rolling elements in a conventional manner with lubricating grease and, instead, the rolling element chamber is flooded with the liquid medium, lubrication thus being accomplished by means of the liquid medium. In particular, it is envisioned that the antifriction bearing is designed without the use of lubricating grease. In this way, it is possible to dispense with sealing of the antifriction bearing, which is critical in respect of manufacture and in respect of the life of the antifriction bearing, while, at the same time, a long life of the antifriction bearing is achieved through lubrication by means of the liquid medium.

In an example embodiment of the invention, at least one annular gap, in particular a free annular gap, which connects the medium chamber and the rolling element chamber to one another in terms of flow, is formed around the pump shaft. At least one free annular gap means, in particular, that the flow connection can be extended further in the radial direction too, although the narrowest regions are implemented only as an annular gap. The annular gap can be fully open or open only in some section or sections in the direction of revolution.

The annular gap ensures that the rolling element chamber can be adequately supplied with the liquid medium at all times.

In an example embodiment of the invention, the pump has a seal, wherein the seal is arranged on a side of the antifriction bearing which faces away from the medium chamber. The seal thus separates the region of the medium chamber in which the antifriction bearing is also arranged from a region into which the liquid medium is not supposed to enter. The seal is arranged in a sealing manner between the pump housing section and the pump shaft.

In an example embodiment of the invention, the seal is designed as a mechanical seal. As a particular preference, the mechanical seal comprises a sealing ring, a supporting ring and a spring, wherein the supporting ring is arranged in a manner which prevents axial movement on the pump shaft, wherein the sealing ring seals with respect to the pump housing section in the axial direction and with respect to the pump shaft in the radial direction and wherein the spring is supported on the supporting ring and presses the sealing ring against the pump housing section in the axial direction. By means of a mechanical seal of this kind, the medium chamber extended into the antifriction bearing is reliably sealed off.

In an example embodiment of the invention, the components of the antifriction bearing, in particular an inner race, an outer race and/or the rolling elements, can be manufactured from a material which is corrosion-resistant in relation to the medium. In principle, it is possible here for special materials, e.g. ceramics, plastic etc., to be used. However, in an example embodiment, the material is designed as a corrosion-resistant steel. In this context, it is possible for the material to be designated as a corrosion-resistant case-hardened steel, e.g. Cronitect made by the applicant, or as a nitrogen-alloyed chromium steel, e.g. X30Cr1MoN15-1 (AMS5998) and/or Cronidur 30 made by the applicant. These known steel grades are known for good corrosion resistance and are widely available in the industrial sector.

The medium is designed as a coolant. In the simplest form, a coolant is understood to be water, deionized water or a mixture of water and antifreeze. Glycerol, ethylene glycol or ethanol is preferably used as an antifreeze.

The pump is designed as a coolant pump for the internal combustion engine of the vehicle. In this case, the coolant pump is used to pump the coolant in order to pass the latter through the internal combustion engine and, as an optional supplementary measure, through one or more radiators.

Accordingly, the pump is designed as a coolant pump for supplying the internal combustion engine with the coolant as the medium.

### BRIEF DESCRIPTION OF THE DRAWINGS

Further features, advantages and effects of the disclosure will become apparent from the following description of a preferred illustrative embodiment of the invention and from the attached figures, of which:

FIG. 1 shows a schematic longitudinal section through an example embodiment of a coolant pump.

FIG. 2 shows another schematic longitudinal section through the coolant pump shown in FIG. 1, incorporated into a vehicle.

### DETAILED DESCRIPTION

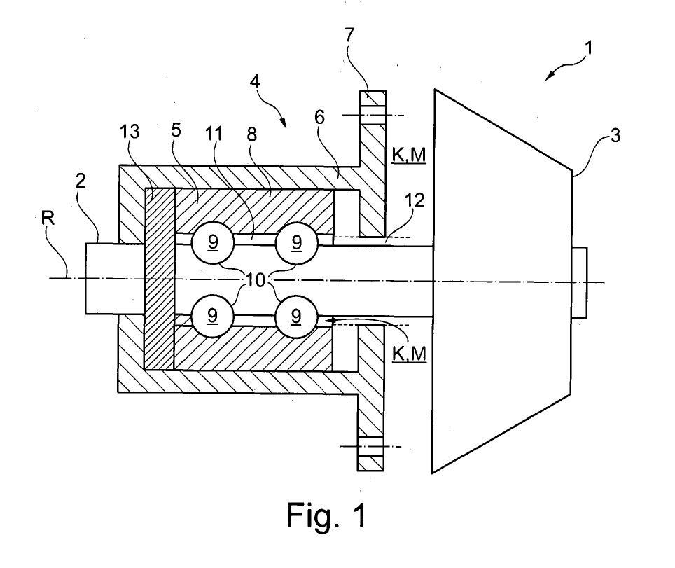

FIG. 1 shows, in a highly schematized illustration, a pump 1, which is designed as a coolant pump for delivering a coolant K as a liquid medium in a vehicle for the purpose of cooling an internal combustion engine. The pump 1 has a pump shaft 2, which is mounted in such a way as to be rotatable about an axis of rotation R and which carries a vane wheel impeller 3 as a pump member at a free end. The vane wheel impeller 3 is rotated about the axis of rotation R together with the pump shaft 2 and has a roughly frustoconical shape in the longitudinal section illustrated, wherein the frustoconical shape is formed by vanes of the vane wheel impeller 3 in order to transfer the coolant K as the liquid medium.

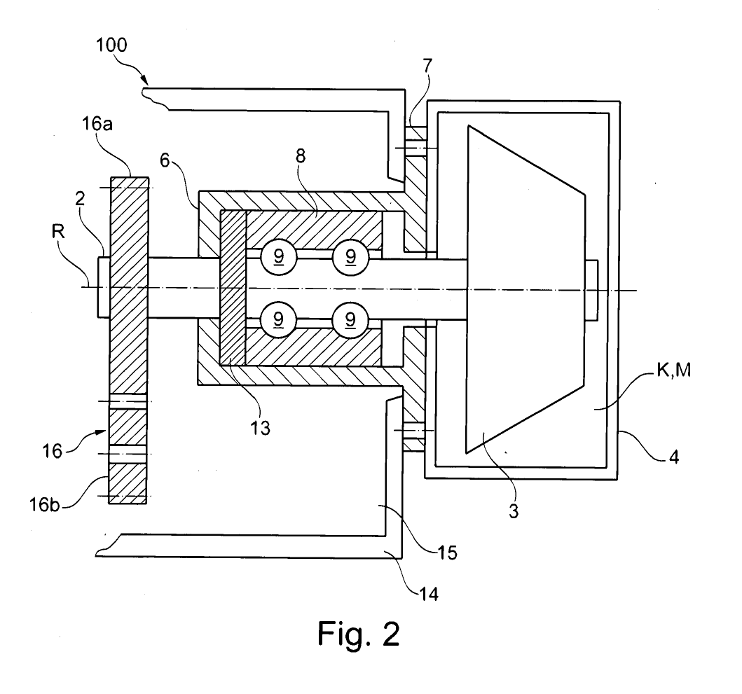

Together with at least one section of the pump shaft 2, the vane wheel impeller 3 is arranged in a medium chamber M, in which the coolant K is present as the liquid medium. In particular, the medium chamber M is completely filled with the coolant K (see also FIG. 2).

The pump 1 has a pump housing section 4, in which the pump shaft 2 is rotatably mounted by means of an antifriction bearing 5. The antifriction bearing 5 preferably forms the only bearing support for the pump shaft 2. The pump housing section 4 can be subdivided into a receiving section 6 and a flange section 7, wherein the pump housing section 4 can be screwed by means of the flange section 7 onto a further pump housing section 4′, which is not shown here (see FIG. 2) and forms a perimeter of the medium chamber M. The receiving section 6 is designed as a hollow cylinder section. The antifriction bearing 5 has an outer race 8 and a plurality of rolling elements 9, which, in this example, are designed as two rows of balls. On the radial inner side, the rolling elements 9 run on raceways 10, which are arranged directly on the pump shaft 2. As an alternative, it is also possible to provide an inner race which carries the raceways and which is mounted on the pump shaft 2. A rolling element chamber 11 is formed radially within the outer race 8, wherein the rolling elements 9 are arranged in the rolling element chamber 11.

It is envisaged that the medium chamber M is connected to the rolling element chamber 11 in terms of flow, thus allowing the coolant K to enter the rolling element chamber 11 and lubricate the rolling elements 9 there. For this purpose, there remains at least one annular gap 12, which extends from the medium chamber M as far as the rolling element chamber 11. Via this annular gap 12, the coolant K can flow from the medium chamber M to the rolling elements 9.

The rolling elements 9, the outer race 8 and optionally the inner race can be manufactured from a corrosion-resistant steel, in particular Cronidur 30 or Cronitect. This ensures that the antifriction bearing 5 does not corrode in the environment containing the coolant K, shortening the life of the antifriction bearing 5. In the antifriction bearing 5, the coolant K has the function of lubricating the rolling elements 9 in order in this way to keep friction in the antifriction bearing 5 low.

A seal, which is implemented as a mechanical seal 13 in this illustrative embodiment, is provided on the side of the pump shaft 2 facing away from the vane wheel impeller 3. The mechanical seal 13 allows radial and axial sealing of the pump shaft 2 with respect to the pump housing section 4.

Thus, the medium chamber M extends from the vane wheel impeller 3, along the pump shaft 2, via the annular gap 12, to the rolling element chamber 11 and is ended only by the seal, designed as a mechanical seal 13. In accordance with its intended purpose, there is no longer any coolant K on the side of the mechanical seal 13 facing away from the vane wheel impeller 3; on the contrary, a driving device or a mechanical interface for driving the pump shaft 2 can be provided there.

FIG. 2 shows another schematic longitudinal section through the pump 1 shown in FIG. 1, incorporated into a vehicle 100. In this case, the vehicle 100 is here illustrated in simplified form solely by an internal combustion engine housing 14 filled with engine oil 15. Identical reference signs to those in FIG. 1 designate identical elements. The vane wheel impeller 3 is situated in a further pump housing section 4′, which is screwed to pump housing section 4. Here, the pump shaft 2 is connected to a transmission stage 16 comprising two input wheels 16a, 16b. In this case, the transmission stage 16 can be driven either by the internal combustion engine or by an electric motor (not shown here). As an alternative, however, the pump shaft 2 can also be driven by means of a conventional belt drive.

### LIST OF REFERENCE CHARACTERS

1 pump

2 pump shaft

3 vane wheel impeller

4, 4′ pump housing section

5 antifriction bearing

6 receiving section

7 flange section

8 outer race

9 rolling elements

10 raceways

11 rolling element chamber

12 annular gap

13 mechanical seal

14 internal combustion engine housing

15 engine oil

16 transmission stage

16a, 16b input wheel

K coolant

R axis of rotation

M medium chamber

1. (canceled)

2. (canceled)

3. (canceled)

4. (canceled)

5. (canceled)

6. (canceled)

7. A coolant pump configured for an internal combustion engine, comprising:
a pump shaft for driving an impeller, the impeller configured to move a liquid medium in a medium chamber, and the pump shaft arranged at least in a section of the medium chamber;
a pump housing section that receives the pump shaft; the pump shaft mounted to the pump housing section via an anti-friction bearing having a plurality of rolling elements arranged in a rolling element chamber, the rolling element chamber fluidly connected to the medium chamber; and,
the anti-friction bearing configured to be lubricated with the liquid medium from the medium chamber.

8. The coolant pump of claim 7, wherein an inner raceway of the anti-friction bearing is arranged directly on the pump shaft.

9. The coolant pump of claim 7, wherein the anti-friction bearing comprises two rows of rolling elements.

10. The coolant pump of claim 7, wherein at least one annular gap is formed around the pump shaft, the at least one annular gap fluidly connecting the rolling element chamber to the medium chamber.

11. The coolant pump of claim 7, further comprising a seal arranged on a side of the anti-friction bearing which faces away from the medium chamber.

12. The coolant pump of claim 11, wherein the seal allows radial and axial sealing of the pump shaft within the pump housing section.

13. The coolant pump of claim 11, wherein the seal is a mechanical seal.

14. The coolant pump of claim 7, wherein components of the anti-friction bearing are manufactured from a material that is corrosion resistant in relation to the liquid medium.

15. The coolant pump of claim 14, wherein the material is a nitrogen-alloyed chromium steel or a corrosion-resistant case-hardened steel.

16. An internal combustion engine comprising:
an engine coolant;
a coolant pump having:
a pump shaft for driving an impeller, the impeller configured to move the engine coolant in a medium chamber, and the pump shaft arranged at least in a section of the medium chamber;
a pump housing section that receives the pump shaft; the pump shaft mounted to the pump housing section via an anti-friction bearing having a plurality of rolling elements arranged in a rolling element chamber, the rolling element chamber fluidly connected to the medium chamber; and,
the anti-friction bearing configured to be lubricated with the engine coolant from the medium chamber.

17. The internal combustion engine of claim 16, wherein the pump shaft is driven by a belt.

18. The internal combustion engine of claim 16, wherein the pump shaft is driven by an input wheel.

19. The internal combustion engine of claim 18, wherein the input wheel is driven by either the internal combustion engine or an electric motor.

20. A vehicle comprising:
an internal combustion engine having:
an engine coolant;
a coolant pump having:
a pump shaft for driving an impeller, the impeller configured to move the engine coolant in a medium chamber, and the pump shaft arranged at least in a section of the medium chamber;
a pump housing section that receives the pump shaft; the pump shaft mounted to the pump housing section via an anti-friction bearing having a plurality of rolling elements arranged in a rolling element chamber, the rolling element chamber fluidly connected to the medium chamber; and,
the anti-friction bearing configured to be lubricated with the engine coolant from the medium ch
